(19) United States
(12) Patent Application Publication
(10) Pub. No.: US 2026/0328259 A1
(43) Pub. Date: Oct. 22, 2026

(54) VIBRATION REDUCTION DEVICES

(71) Applicant: Hewlett-Packard Development Company, L.P., Spring, TX (US)

(72) Inventors: Chih-Hua Chen, Taipei City (TW); Sheng-Tien Chang, Taipei City (TW); Chin-Chang Ho, Taipei City (TW); Lien-Chia Chiu, Taipei City (TW)

(73) Assignee: Hewlett-Packard Development Company, L.P., Spring, TX (US)

(21) Appl. No.: 19/111,258

(22) PCT Filed: Sep. 30, 2022
(86) PCT No.: PCT/US2022/045327

§ 371 Date: Mar. 12, 2025

(51) Int. Cl. F16F 15/02

(52) U.S. Cl. CPC F16F 15/02; F16F 2232/08; F16F 2238/04

(57) ABSTRACT

In some examples, a device can include a chassis, a motor module connected to the chassis via a fastener and a damper, the damper to receive the fastener through an aperture of the damper, where the damper is to provide an isolation gap between a surface of the chassis and the motor module, and a door connected to the chassis, where the motor module is to cause the door to translate from a first position to a second position, and the damper is to reduce vibration experienced by the chassis during translation of the door.

### BACKGROUND

Users of computing devices may utilize their computing devices for various purposes. A computing device can allow a user to utilize computing device operations for work, education, gaming, multimedia, and/or other general use.

Certain computing devices can be portable to allow a user to carry or otherwise bring with the computing device while in a mobile setting, while other computing devices may not be portable but allow a user to utilize the computing device in an office or home setting.

### BRIEF DESCRIPTION OF THE DRAWINGS

FIG. 1 is an exploded perspective view of an example of a device having vibration reduction devices consistent with the disclosure.

FIG. 2A is a perspective view of an example of a damper consistent with the disclosure.

FIG. 2B is a side view of an example of a damper consistent with the disclosure.

FIG. 3 is an exploded side-section view of an example of a device including a motor module and a damper consistent with the disclosure.

FIG. 4 is an exploded detailed side-section view of an example of a device including a chassis and a step screw boss consistent with the disclosure.

FIG. 5 is a side-section view of an example of a device including a motor module and a damper consistent with the disclosure.

FIG. 6 is a perspective view of an example of a computing device having a media bar consistent with the disclosure.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer (e.g., a computing device in which computing hardware and a display device are included in a single housing), a mobile device, or a conference room computer or control device, among other types of computing devices.

Various computing devices may utilize a media bar. As used herein, the term “media bar” refers to an enclosure having various devices for media. A media bar may include various devices such as a speaker, a camera, a microphone, etc. The media bar including the various devices may be utilized for various purposes, such as for entertainment (e.g., listening to music, etc.), for electronic meetings, lectures, among other purposes.

Sound quality from the media bar may be a deciding factor for certain consumers when considering a media bar. In some examples, some users may desire sound quality levels for enjoyment of media such as audio, video, etc. In some examples, some users may desire sound quality levels in order to clearly understand information from an electronic meeting, lecture, etc.

In some examples, some users may desire a media bar with aesthetically pleasing looks. Accordingly, a media bar may include a door/doors that can cover the media bar when the media bar is not in use. For example, the door can be in a closed position to cover the speaker, camera, microphone, and/or other devices included in the media bar when the media bar is not in use in order to create an aesthetically pleasing look to the media bar.

When the media bar is to be utilized, the door can translate to an open position, exposing the various devices included in the media bar. Accordingly, the speaker may provide quality sound desired by a user when the media bar is being utilized.

However, translation of the door can cause vibrations in the media bar. Such vibration may be caused by a device causing the door of the media bar to translate, such as a motor module. For example, magnetic switching, gears, threaded rollers, and/or bearings of the motor module may be sources of vibration from the motor module causing the door to translate. Such vibration may cause noise, which can negatively affect quality perception of the media bar by a user. In some examples, such vibration may affect the sound quality of the media bar.

Vibration reduction devices according to the disclosure can allow for a reduction in vibration experienced by the media bar during door translation, as compared with previous approaches. Accordingly, users of the media bar may be less aware of or not notice any vibration experienced by the sound bar during door translation, allowing for a media bar with aesthetically pleasing looks as well as a positive user experience from users of the media bar.

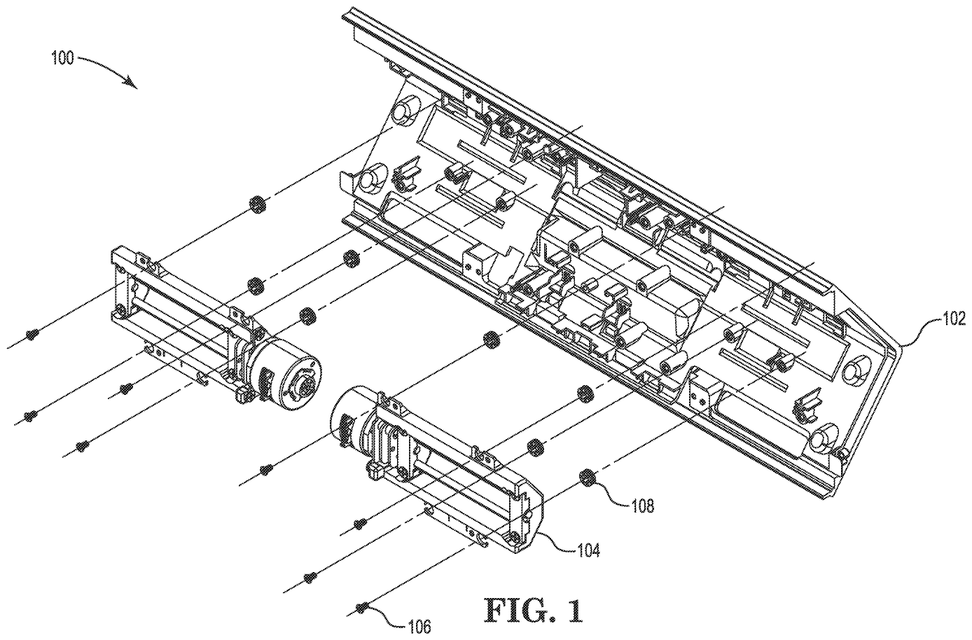

FIG. 1 is an exploded perspective view of an example of a device 100 having vibration reduction devices consistent with the disclosure. As illustrated in FIG. 1, the device 100 includes a chassis 102 and a motor module 104.

The device 100 can include a chassis 102. As used herein, the term “chassis” refers to a structural framework of a device. For example, the chassis 102 can serve as a structural framework of the device 100. As mentioned above, the device 100 can be a media bar. Various components of the media bar can be connected to the chassis 102. For example, a speaker, a camera, a microphone, a door, a motor module 104, etc. may be connected (e.g., directly or indirectly) to the chassis 102.

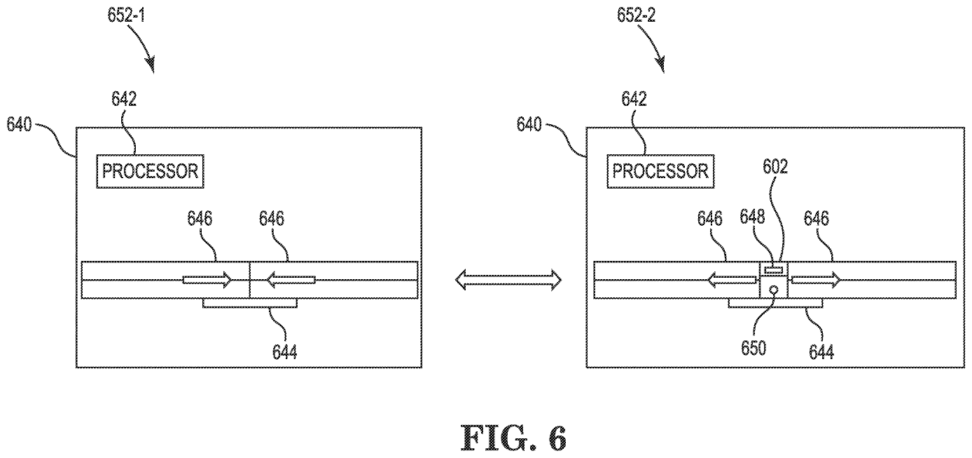

As mentioned above, a motor module 104 may be connected to the chassis 102. As used herein, the term “motor module” refers to a device comprising a set of parts that supply power to another device with moving parts. For example, the motor module 104 may be comprised of various parts that can cause a door (e.g., not illustrated in FIG. 1) to translate between an open and closed position, as is further described herein with respect to FIG. 6. Such parts of the motor module 104 may include a rotational electric motor having a rotor and stator, a linear motor, gears, worm drive, linkages, etc.

The motor module 104 can be connected to the chassis 102 via a fastener 106. As used herein, the term “fastener” refers to a device that mechanically joins objects together. For example, the fastener 106 can be a threaded fastener that can include an external male thread that can be received by a matching female thread included in a tapped housing included on the chassis 102. However, examples of the disclosure are not limited to threaded fasteners. For example, the fastener 106 can be a rivet, a self-tapping fastener, a bolt and nut, etc.

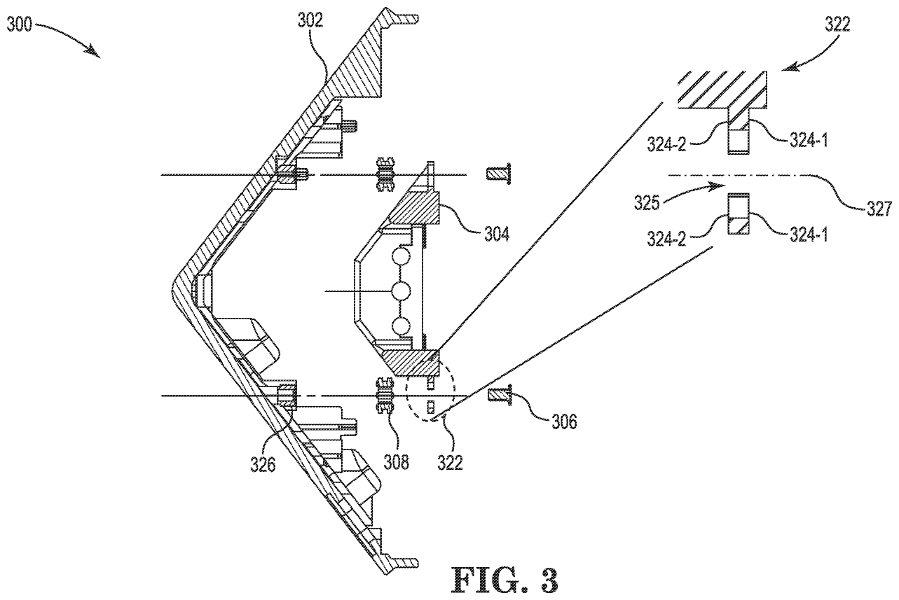

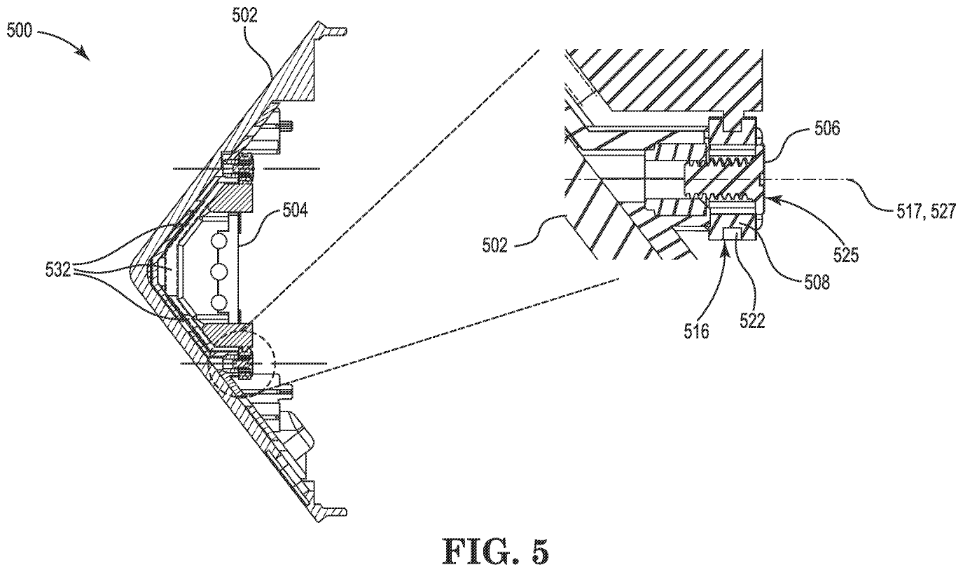

The motor module 104 may additionally be connected to the chassis 102 via a damper 108. As used herein, the term “damper” refers to a device that reduces mechanical vibration. As illustrated in FIG. 1, the damper can include an aperture that can receive the fastener 106. Accordingly, when the fastener 106 is oriented in the aperture of the damper 108 (e.g., and through a connection flange of the motor module 104, as is further described in connection with FIGS. 3-5), the damper 108 is to provide an isolation gap between a surface of the chassis 102 and the motor module 104 (e.g., as is further described in connection with FIG. 5). As used herein, the term “isolation gap” refers to a space between two objects. Accordingly, the damper 108 is to reduce vibration experienced by the chassis 102 during translation of the door (e.g., caused by the motor module 104) via the isolation gap created by the damper 108 between the motor module 104 and the chassis 102, as is further described herein.

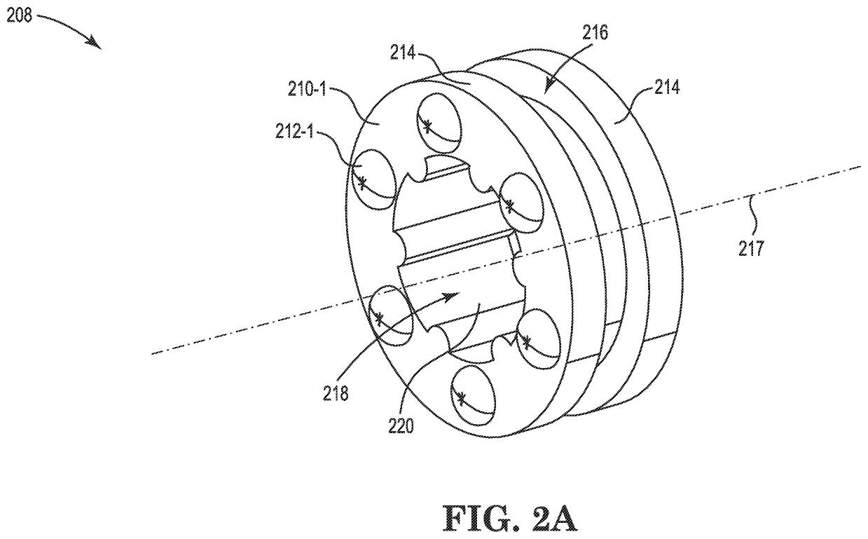

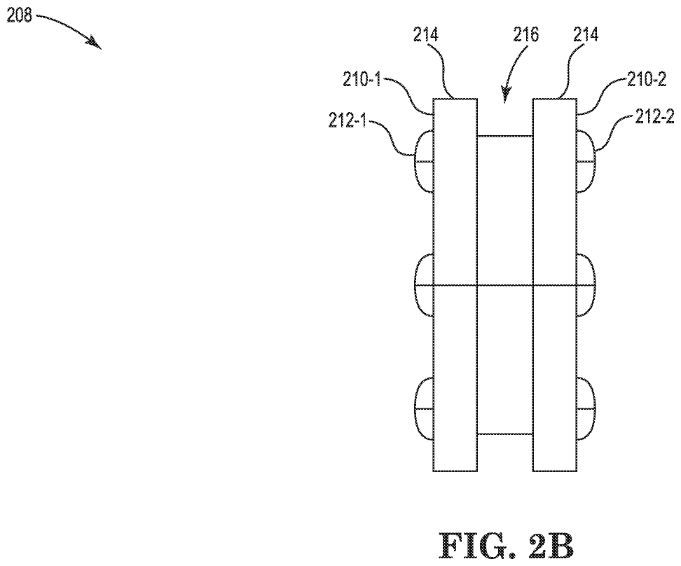

FIG. 2A is a perspective view of an example of a damper 208 consistent with the disclosure. The damper 208 can include a surface 210-1, an outer ring surface 214, a channel 216, and an aperture 218.

The damper 208 can include a first surface 210-1. The first surface 210-1 can include a first protrusion 212-1. As used herein, the term “protrusion” refers to a projection of material from a surface. As illustrated in FIG. 2A, the first protrusion 212-1 can be a semi-spherical protrusion. For example, the first protrusion 212-1 can be in the shape of a half-circle. However, examples of the disclosure are not so limited to semi-spherical protrusions. For instance, the first protrusion 212-1 can be any other shape (e.g., a rib of material (continuous or sectioned) forming a ring around the surface 210-1 of the damper 208, in the shape of a rectangular prism (a curved rectangular prism, a straight rectangular prism, etc.), a cube, a triangular prism, any other irregular prism shape, and/or any combination thereof).

The first protrusion 212-1 can be one protrusion included in a group of protrusions included on the first surface 210-1. For example, as illustrated in FIG. 2A, the first surface 210-1 can include six protrusions 212-1 oriented around an axis 217 and a circumferential edge of the damper 208. In some examples, the damper 208 can include more than six protrusions 212-1 or less than six protrusions 212-1.

The protrusions 212-1 can be utilized to be in contact with a surface of a different module included in the media bar in order to reduce a contact area between the damper 208 and the other module of the media bar. Such an approach to reducing the contact area can reduce the transfer of vibration between the motor module and the different module of the media bar.

Although not illustrated in FIG. 2A, the damper further includes a second surface. The second surface is opposite the first surface 210-1 and can include a second protrusion located thereon, as is further described in connection with FIG. 2B.

The damper 208 can include a damper aperture 218 having an inner aperture surface 220. As used herein, the term “aperture” refers to an opening through an object. For example, the damper aperture 218 can be an opening through the damper 208 having an axis 217. When the damper 208 is interfaced with the motor module, the inner aperture surface 220 can be located proximate to a connection flange of a motor module, as is further described in connection with FIG. 5.

The damper 208 further includes an outer ring surface 214 including a channel 216. The outer ring surface 214 can be adjacent to and oriented substantially normal to the first surface 210-1 and the second surface of the damper 208. As used herein, the term “channel” refers to an opening through a portion of material. The channel 216 can be an opening through a portion of the outer ring surface 214 of the channel around a circumference of the damper 208. When the damper 208 is interfaced with the motor module, the channel 216 can interface with the connection flange of the motor module, as is further described in connection with FIG. 5.

Accordingly, as described above, the damper 208 can be shaped as a toroidal prism. As used herein, the term “toroidal prism” refers to a ring-shaped object with a hollow section. That is, the damper 208 can be shaped as a substantially rectangular section ring having a hollow middle portion.

FIG. 2B is a side view of an example of a damper 208 consistent with the disclosure. The damper 208 can include a first surface 210-1, a second surface 210-2, an outer ring surface 214, and a channel 216.

As previously described in connection with FIG. 2A, the damper 208 can include a first surface 210-1 having first protrusion 212-1. Similarly, the damper 208 can include a second surface 210-2 having second protrusions 212-2. The second surface 210-2 can be oriented substantially normal to the outer ring surface 214 including the channel 216.

As illustrated in FIG. 2B, the second protrusion 212-2 can be a semi-spherical protrusion. For example, the second protrusion 212-2 can be in the shape of a half-circle. However, examples of the disclosure are not so limited to semi-spherical protrusions. For instance, the second protrusion 212-2 can be any other shape (e.g., a rib of material (continuous or sectioned) forming a ring around the surface 210-2 of the damper 208, in the shape of a rectangular prism (a curved rectangular prism, a straight rectangular prism, etc.), a cube, a triangular prism, any other irregular prism shape, and/or any combination thereof).

Additionally, the second protrusion 212-2 can be one protrusion included in a group of protrusions on the second surface 210-2. The group of protrusions on the second surface 210-2 can be the same number of protrusions as on the first surface 210-1 or a different number of protrusions. Additionally, the shape of the second protrusion 212-2 can be the same shape as the first protrusion 212-1 or a different shape.

The protrusions 212-2 can be utilized to be in contact with a surface of the chassis in order to reduce a contact area between the damper 208 and the surface of the chassis. Such an approach to reducing the contact area can reduce the transfer of vibration between the motor module and the chassis.

FIG. 3 is an exploded side-section view of an example of a device 300 including a motor module 304 and a damper 308 consistent with the disclosure. As illustrated in FIG. 3, the motor module 304 can include a connection flange 322.

As illustrated in FIG. 3, the motor module 304 can include a connection flange 322. As used herein, the term “flange” refers to an external or internal ridge or rim of material to provide a location for attachment or placement of another object. The connection flange 322 can be a rim of material used to attach the motor module 304 to the chassis 302 utilizing the fastener 306 and the damper 308, as is further described herein.

As shown in the detail view of the connection flange 322, the connection flange 322 can include a first surface 324-1, a second surface 324-2, and a connection flange aperture 325 having an axis 327. The second surface 324-2 can be opposite the first surface 324-1. The motor module 304 can be connected to the chassis 302 via the damper 308 and the fastener 306, as is further described herein.

The damper can be partially located between the second surface 324-2 of the connection flange 322 and the chassis 302. The fastener 306 can interface with a first surface of the damper (e.g., first surface 210-1, previously described in connection with FIGS. 2A and 2B) and be located in the aperture (e.g., damper aperture 218, previously described in connection with FIGS. 2A and 2B) of the damper 308. Accordingly, the damper 308 can provide a physical isolation gap between a surface of the chassis 302 and the motor module 304, as is further described in connection with FIG. 5.

The chassis 302 can include a boss 326. As used herein, the term “boss” refers to a cylindrical protrusion on a piece of material. The boss 326 can, in some examples, be a tapped housing that includes a thread (e.g., a female thread), where an external thread of the fastener 306 can be received by the thread in the boss 326 to secure the fastener 306 in the boss 326. That is, the boss 326 can receive the fastener 306 such that the fastener 306 is partially and coaxially located in the boss 326. The boss 326 can receive the fastener 306 such that the damper 308 is located between the boss 326 and the motor module 304. Accordingly, the fastener 306 can be coaxially located with the axis 327 of the connection flange aperture 325, as well as coaxially located with the axis (e.g., axis 217, previously described in connection with FIG. 2A) of the aperture (e.g., damper aperture 218, previously described in connection with FIG. 2A) of the damper 308.

In some examples, the boss 326 can be longer or shorter than the length illustrated in FIG. 3. For example, the boss 326 can extend further out from the chassis 302. Such a variance in length of the boss 326 can provide different physical isolation gaps between the motor module 304 and the chassis 302. A larger physical isolation gap (e.g., as a result of a longer boss 326) may prevent vibration better than a shorter isolation gap (e.g., as a result of the boss 326 illustrated in FIG. 3). However, in some examples, the boss 326 may be shorter as a result of spatial limitations in the design of the media bar, while still providing vibration reduction as compared with previous approaches.

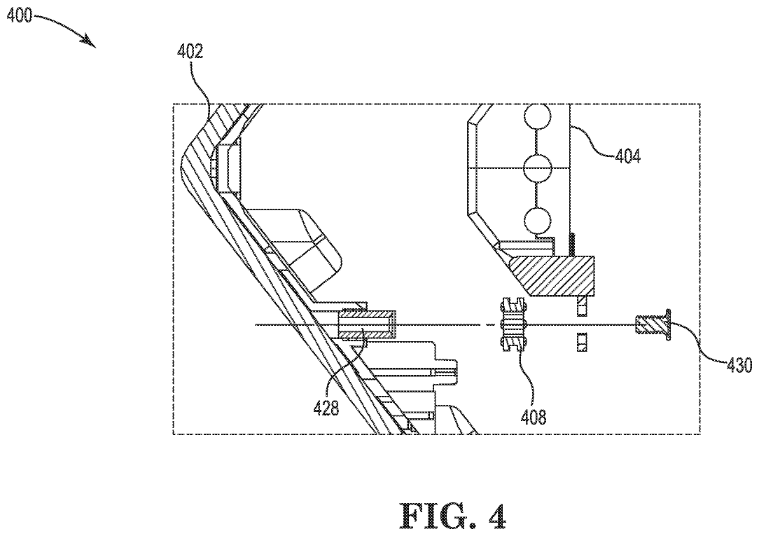

FIG. 4 is an exploded detailed side-section view of an example of a device 400 including a chassis 402 and a step screw boss 428 consistent with the disclosure. As illustrated in FIG. 4, the device 400 includes the chassis 402, a motor module 404, and a damper 408.

As illustrated in FIG. 4, the chassis 402 includes a step screw boss 428. As used herein, the term “step screw boss” refers to a cylindrical protrusion on a piece of material that is to interface with a step screw. For example, the fastener (e.g., fastener 306, previously described in connection with FIG. 3) can be a step screw 430. As used herein, the term “step screw” refers to a fastener with an interrupted, stepped helical thread.

For example, the step screw 430 can be received by the by the step screw boss 428 to secure the step screw 430 in the step screw boss 428. In some examples, the step screw boss 428 can be a different length as compared with the boss 326, previously described in connection with FIG. 3. Such boss lengths can allow for different widths of the physical isolation gap between the motor module 404 and the chassis 402.

FIG. 5 is a side-section view of an example of a device 500 including a motor module 504 and a damper 508 consistent with the disclosure. As illustrated in FIG. 5, a physical isolation gap 532 exists between the motor module 504 and the chassis 502.

As illustrated in FIG. 5, the motor module 504 is connected to the chassis 502 via the fastener 506 and the damper 508. For example, the fastener 506 can be coaxially located with the axis 527 of the connection flange aperture 525 and with the axis 517 of the damper 508. Additionally, the fastener 506 and the damper 508 are coaxially located with the connection flange aperture 525 such that a portion of the connection flange 522 is located in the channel 516 of the outer ring surface of the damper 508. Accordingly, the damper 508 can be in contact with the connection flange 522 and the chassis 502. The portion of the connection flange 522 being located in the channel 516 of the damper 508 can secure the damper 508 to the connection flange 522 of the motor module 504.

Although not illustrated in FIG. 5, in some examples the device 500 can include a different module. The different module can be, for example, a speaker, microphone, camera, and/or any other part included in the device 500 that may contact the damper 508. Accordingly, the protrusions (e.g., protrusions 212-1, previously described in connection with FIGS. 2A and 2B) of the first surface (e.g., first surface 210-1, previously described in connection with FIGS. 2A and 2B) can be in contact with the different module to reduce a contact area between the damper 508 and the different module.

Additionally, the damper 508 can include a second surface (e.g., second surface 210-2, previously described in connection with FIGS. 2A and 2B) having second protrusions (e.g., protrusions 212-2, previously described in connection with FIGS. 2A and 2B). The second protrusions can be in contact with the chassis 502 to reduce a contact area between the damper 508 and the chassis 502.

FIG. 6 is a perspective view of an example of a computing device 640 having a media bar 644 consistent with the disclosure. As illustrated in FIG. 6, the computing device 640 further includes a processor 642.

The media bar 644 can include a chassis 602, a speaker 648 connected to the chassis 602, a camera 650 connected to the chassis 602, a door 646 connected to the chassis 602, and a motor module (e.g., not illustrated in FIG. 6). The motor module can be connected to the chassis 602 via a damper and a fastener. For example, as previously described in connection with FIGS. 1-5, the motor module can be connected to the chassis via a fastener coaxially located with an aperture of a damper, and the damper can be coaxially located with an aperture of a connection flange of the motor module. The damper can create a physical isolation gap between the chassis 602 and the motor module, which can reduce vibrations experienced by the chassis generated by the motor module as the motor module causes the door 646 to translate, as is further described herein.

As illustrated at 652-1, the door 646 is in a closed position. In the closed position, the door 646 can cover the speaker 648 and camera 650 of the media bar 644. However, in an instance in which the media bar 644 is to be used, the processor 642 can cause the door 646 to translate (e.g., substantially horizontally) to an open position (e.g., as illustrated at 652-2), exposing the speaker 648 and the camera 650. For example, the processor 642 can cause the motor module to activate, causing the door 646 to translate from the closed position to the open position.

In previous approaches, during translation of the door from the closed position to the open position vibrations may be experienced by the chassis and/or other parts of the media bar 644. The physical isolation gap created by the damper between the chassis 602 and the motor module can reduce such vibrations experienced by the media bar 644 during translation of the door 646 from the closed position (e.g., at 652-1) to the open position (e.g., at 652-2). Accordingly, with the doors in the open position at 652-2, the user can utilize the media bar 644 to listen to sound output by the speaker 648, utilize the camera 650, etc.

The processor 642 can be a processing resource such as a central processing unit (CPU), microprocessor, and/or other hardware device suitable for retrieval and execution of instructions stored in a non-transitory machine-readable storage medium (e.g., not illustrated in FIG. 6). As an alternative or in addition to retrieving and executing instructions, the processing resource may include an electronic circuit comprising a number of electronic components for performing the operations of the instructions in the non-transitory machine-readable storage medium.

The non-transitory machine-readable storage medium may be any electronic, magnetic, optical, or other physical storage device that stores executable instructions. Thus, the non-transitory machine-readable storage medium may be, for example, Random Access Memory (RAM), an Electrically-Erasable Programmable Read-Only Memory (EEPROM), a storage drive, an optical disc, and the like. The executable instructions may be “installed” in the non-transitory machine-readable storage medium. The non-transitory machine-readable storage medium may be a portable, external or remote storage medium, for example, that allows the computing device 640 to download the instructions from the portable/external/remote storage medium. In this situation, the executable instructions may be part of an “installation package”.

Vibration reduction devices can allow for a reduction in vibration experienced by a media bar as a result of operation of a motor module by utilizing a physical isolation gap between a chassis of the media bar and the motor module, the physical isolation gap being created via a damper. Such an approach can allow for a media bar with aesthetically pleasing looks as well as a positive user experience without compromise of acoustic qualities of the speaker.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 108 in FIG. 1 and an analogous element may be identified by reference numeral 208 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A device, comprising:
a chassis;
a motor module connected to the chassis via a fastener and a damper, the damper to receive the fastener through an aperture of the damper, wherein the damper is to provide an isolation gap between a surface of the chassis and the motor module; and
a door connected to the chassis;
wherein:
the motor module is to cause the door to translate from a first position to a second position; and
the damper is to reduce vibration experienced by the chassis during translation of the door.

2. The device of claim 1, wherein the fastener is to interface with a first surface of the damper.

3. The device of claim 2, wherein the damper is partially located between a second surface of a connection flange of the motor module and the chassis.

4. The device of claim 3, wherein the second surface of the connection flange is opposite the first surface of the connection flange.

5. The device of claim 1, wherein:
the chassis includes a boss; and
the boss is to receive the fastener such that the damper is located between the boss and the motor module.

6. The device of claim 5, wherein the boss is a step screw boss and the fastener is a step screw.

7. A media bar, comprising:
a chassis;
a motor module including a connection flange having a first surface and a second surface opposite the first surface, wherein:
the motor module is connected to the chassis via a damper having an aperture and a fastener located in the aperture; and
the damper is partially located between the second surface and the chassis to provide a physical isolation gap between a surface of the chassis and the motor module; and
a door connected to the chassis;
wherein:
the motor module is to cause the door to translate from a first position to a second position; and
the damper is to reduce vibration experienced by the chassis during translation of the door.

8. The media bar of claim 7, wherein the damper is in contact with the connection flange and the chassis.

9. The media bar of claim 7, wherein the damper includes a first surface having a first protrusion located thereon, the first protrusion being in contact with a different module of the media bar to reduce a contact area between the damper and the different module.

10. The media bar of claim 7, wherein the damper includes a second surface having a second protrusion located thereon, the second protrusion being in contact with the chassis to reduce a contact area between the damper and the chassis.

11. The media bar of claim 7, wherein the damper is shaped as a toroidal prism.

12. A computing device, comprising:
a media bar including:
a chassis;
a speaker connected to the chassis;
a motor module including a connection flange having a first surface, a second surface opposite the first surface, and a connection flange aperture, wherein:
the motor module is connected to the chassis via a damper having a damper aperture and a fastener located in the damper aperture, wherein the fastener is coaxially located with the damper aperture and the fastener and damper are coaxially located with the connection flange aperture; and
the damper is partially located between the second surface and the chassis to provide a physical isolation gap between a surface of the chassis and the motor module;
a door connected to the chassis; and
a camera connected to the chassis; and
a processor to cause the door to translate from a closed position to an open position;
wherein:
the door is to cover the camera and the speaker when the door is in the closed position; and
the damper is to reduce vibration experienced by the media bar during translation of the door caused by the motor module.

13. The computing device of claim 12, wherein the damper includes a first surface, a second surface opposite the first surface, an outer ring surface including a channel, and an inner aperture surface, wherein the outer ring surface is located adjacent to and oriented substantially normal to the first surface and the second surface of the damper.

14. The computing device of claim 13, wherein the fastener and the damper are coaxially located with the connection flange aperture such that a portion of the connection flange is located in the channel of the outer ring surface of the damper.

15. The computing device of claim 12, wherein:
the chassis includes a boss; and
the fastener is partially and coaxially located in the boss.
